(19) United States
(12) Patent Application Publication
(10) Pub. No.: US 2025/0328712 A1
(43) Pub. Date: Oct. 23, 2025

(54) COMPUTER-IMPLEMENTED SYSTEM AND METHOD FOR ELECTRONIC SYSTEMS DESIGN SYNCHRONIZATION

(71) Applicant: SKYECHIP SDN BHD, BAYAN LEPAS (MY)

(72) Inventors: Chin Choi Phaik, BAYAN LEPAS (MY); Eric Khoo Wey Ming, BAYAN LEPAS (MY)

(73) Assignee: SKYECHIP SDN BHD, BAYAN LEPAS (MY)

(21) Appl. No.: 18/891,668

(22) Filed: Sep. 20, 2024

(30) Foreign Application Priority Data
Apr. 18, 2024 (MY) PI2024002238

(51) Int. Cl. G06F 30/31; G06F 30/392

(52) U.S. Cl. CPC G06F 30/31; G06F 30/392

(57) ABSTRACT

The present invention relates to a computer-implemented design synchronizing system (1) for designing floorplan of electronic systems. The system (1) characterized by at least two design editors comprise of a physical design editor (11) and a logical design editor (12), the design editors (11, 12) are connected to a design database associated with a unified design model (14), and a synchronization manager (13) manages design synchronization among the design editors (11, 12) by receiving an action from one of the design editors (11, 12), updating the action in the unified design model (14), and broadcasting the action to other design editor, wherein each of the design editors (11, 12) comprises an undo stack (15, 16) to receive an action from a user or broadcast, and to keep track a sequence of actions of the respective design editor, whereby the design editors (11, 12) perform an action according to the action received from the user or broadcast corresponding to the unified design model (14) for design synchronization. A computer-implemented method for design synchronization of electronic systems is also disclosed herein.

### CROSS-REFERENCE TO RELATED APPLICATIONS

This application claims priority to and the benefit of Malaysian Patent Application No. PI2024002238 filed in the Malaysian Intellectual Property Office on Apr. 18, 2024, the entire contents of which are incorporated herein by reference its entirety.

### TECHNICAL FIELD

The present invention relates generally to electronic design automation. More particularly, it relates to computer-implemented system and method for electronic systems design synchronization.

### BACKGROUND ART

Electronic computer-aided design tools such as electronic design automation (EDA) tool comprises software, hardware, and services for designing chips and semiconductor devices. Existing EDA software typically enables design either in the logical or physical floorplan, offering either a physical design editor and a logical floorplan viewer, or vice versa. This approach imposes limitations on usability and flexibility, as both physical and logical floorplans possess unique strengths and advantages in terms of design creation, debugging, and analysis. In other words, existing EDA software does not provide both physical and logical design creation with full synchronization between all common editing actions in EDA. Therefore, there is a need to eliminate the limitation of design creation, debugging, and analysis to either physical or logical design only.

Below are several examples of prior arts related to synchronization in EDA design, online interactive design system, and document editing system.

U.S. Pat. No. 8,453,136B1 discloses a method and an apparatus for allowing several different applications to incrementally collaborate while making changes to a circuit design. The method for synchronizing multiple applications in a distributed system comprising using at least one processor to perform a process. The process comprising making a change to a design by using an electronic circuit design tool, wherein design data for implementing the design are stored in a design database, tracking the change to a first data model of a first process of one of the multiple applications associated with the design, wherein the first process interacts with the first data model to implement the design, generating a change set representation from the change that is tracked, and updating a second data model of a second process at another one of the multiple applications, wherein the second data model is updated with the change set representation regardless of whether a uniform data model that is supported by the multiple applications exists. The prior art supports synchronization of multiple heterogeneous representations of EDA design and technology data.

CN102752330A discloses a multi-person online interactive design system, which comprises an object abstraction module, an operation abstraction module, a conflict detection and resolution module, and a user management and synchronization module, wherein the object abstraction module is used to generate an identifier describing the object in the three-dimensional scene, the operation abstraction module is used to generate an identifier describing the design operation in the three-dimensional scene, and abstract the user's local operation and remote operation into specific data objects for management and maintenance, the conflict detection and resolution module is used to detect and resolve conflict operations and ensure the correctness of the collaborative design, and the user management and synchronization module is used to manage users participating in the collaborative design, and synchronize the scene according to the user's situation to control the user's operation authority. The system allows people located at different geographical positions to participate in the collaborative design at the same time to enhance the design efficiency.

Qinyi Wu et al., Consistency in Real-time Collaborative Editing Systems Based on Partial Persistent Sequences, 16 May 2014, discloses a data consistency model that preserves convergence and synchronizes editing operations only when users access overlapped or contiguous characters. This model addresses data consistency issues arise due to concurrent editing conflicts. The synchronization strategy employs a data structure called partial persistent sequence, which is an ordered set of items indexed by persistent and unique position identifiers. This structure captures data dependencies of editing operations and encodes them to ensure correct execution on any document replica.

It is evident that the existing synchronization systems and methods lack a solution capable of synchronizing all user actions performed in both physical and logical design editors of EDA. Therefore, the present invention aims to address this gap by providing flexibility in physical and logical design creation, debugging, analysis through synchronizing all user actions performed in both design editors.

### SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

It is an objective of the present invention to provide a computer-implemented system and method that can synchronize user actions performed in arbitrary of tools, such as physical and logical design editors.

It is also an objective of the present invention to provide a computer-implemented system and method that allows design creation in either a physical or logical design editor for designing electronic systems.

It is yet another objective of the present invention to provide a computer-implemented design synchronizing system that is fully undo-able and redo-able.

Accordingly, these objectives may be achieved by following the teachings of the present invention. The present invention relates a computer-implemented design synchronizing system for designing electronic systems. The design synchronizing system characterized by at least two design editors comprise of a physical design editor and a logical design editor, the design editors are connected to a design database associated with a unified design model, and a synchronization manager manages design synchronization among the design editors by receiving an action from one of the design editors, updating the action in the unified design model, and broadcasting the action to other design editor, wherein each of the design editors comprises an undo stack to receive an action from a user or broadcast, and to keep track a sequence of actions of the respective design editor, whereby the design editors perform an action according to the action received from the user or broadcast corresponding to the unified design model for design synchronization.

The present invention also relates to a computer-implemented method for design synchronization of electronic systems. The method comprising the steps of receiving an action from a user and transferring the user action to a synchronization manager by a design editor, receiving and analysing the user action, updating the user action in a unified design model, and broadcasting the user action to other design editor by the synchronization manager to manage the design synchronization among the design editors, and receiving the user action from the broadcast by the other design editor to perform the user action, wherein the user action is received and updated to undo stack of each design editor, and the unified design model performs tracking to track the undo stack of each design editor to ensure the design synchronization.

The present invention further relates to a computer program product that comprises instructions for implementing the method for design synchronization of electronic systems as described above.

The foregoing and other objects, features, aspects, and advantages of the present invention will become better understood from a careful reading of a detailed description provided herein below with appropriate reference to the accompanying drawings.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figures, with like reference numbers referring to like structures across the views, wherein:

FIG. 1 is a flow diagram illustrating an embodiment of design synchronization process at a design editor that receives an action from a user;

FIG. 2 is a flow diagram illustrating an embodiment of design synchronization process at a synchronization manager that manages the communication among design editors and a unified design model;

FIG. 3 is a flow diagram illustrating an embodiment of design synchronization process at the other design editor that receives the broadcasted action;

FIG. 4 is a flow diagram illustrating a user action that involves adding a component to a physical design editor;

FIG. 5 is a flow diagram illustrating a user action that involves moving a component in a physical design editor;

FIG. 6 is a diagram illustrating performing an undo user action in a physical design editor; and

FIG. 7 is a diagram illustrating performing a redo user action in a logical design editor.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting but merely as a basis for claims. It should be understood that the drawings and detailed description thereto are not intended to limit the invention to the particular form disclosed, but on the contrary, the invention is to cover all modifications, equivalents and alternatives falling within the scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the words “a” or “an” mean “at least one” and the word “plurality” means one or more, unless otherwise mentioned. Where the abbreviations or technical terms are used, these indicate the commonly accepted meanings as known in the technical field.

The present invention is described hereinafter by various embodiments with reference to the accompanying drawings, wherein reference numerals used in the accompanying drawings correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention. While specific editors are used as examples, the synchronization engine is not limited to such tools, offering broader applicability.

The present invention proposes a computer-implemented design synchronizing system (1) for designing electronic systems.

The system (1) characterized by at least two design editors comprise of a physical design editor (11) and a logical design editor (12), the design editors (11, 12) are connected to a design database associated with a unified design model (14), and a synchronization manager (13) manages design synchronization among the design editors (11, 12) by receiving an action from one of the design editors (11, 12), updating the action in the unified design model (14), and broadcasting the action to other design editor, wherein each of the design editors (11, 12) comprises an undo stack (15, 16) to receive an action from a user or broadcast, and to keep track a sequence of actions of the respective design editor, whereby the design editors (11, 12) perform an action according to the action received from the user or broadcast corresponding to the unified design model (14) for design synchronization.

In accordance with an embodiment of the present invention, the system (1) further comprises a centralized manager for selecting the design editors (11, 12) as recipient of broadcasted actions. More particularly, the centralized manager manages the unified design model (14) and cooperates with the synchronization manager (13) to manage the communication among all the design editors (11, 12). When one of the design editors (11, 12) transfers the user action to the synchronization manager (13), the synchronization manager (13) will broadcast the user action in a message form to the recipient, which is the other design editor, wherein the recipient to receive the broadcasted action is selected by the centralized manager. This empowers a wide range of users involved in the design process, including but not limited to the design editors (11, 12) to choose their preferred tool for creating circuitry design. These applications can encompass a variety of tools, such as text editors for users who prefer a code-based approach, specialized design software offering visual editors and pre-built component, or even custom-built programs tailored to specific design needs and workflows. Notably, the system (1) is not limited to these specific examples. The synchronization engine allows arbitrary design creation tools to be synchronized. The design editors (11, 12) can seamlessly switch between these applications while working collaboratively on the same design. Changes made in one tool are instantly reflected in all other connected through the centralized manager. The design editors (11, 12) can add or remove itself as the recipient of the broadcasted actions. More particularly, the design editors (11, 12) can add itself as a recipient of the broadcasted actions by registering itself as a target of the centralized manager's listener list. As such, when the centralized manager broadcast changes, all targets in the listener list will be notified. To remove itself as a recipient of the broadcasted actions, the design editors (11, 12) need to inform the centralized manager to unregister itself from the listener list. As such, the design editors (11, 12) will stop receiving the broadcasted actions.

In accordance with an embodiment of the present invention, the user actions comprise design creation, edition, deletion, undo, and redo, wherein all the user actions will be updated in the unified design model (14), regardless of the currently active editor. Design-related user action can be done and undone in either physical design editor (11) or logical design editor (12). The physical and logical design editors (11, 12) may obtain the action performed by the user from the unified design model (14). This implies that the sequence of the physical and design editors (11, 12) becoming the active editor does not matter. The opening (active) or closing (inactive) of the design editors does not affect the synchronization process, having said that as long the design editors are added to the listener list of the centralized manager as a recipient. The design editors can receive and synchronize with broadcasted actions regardless of their opened or closed state. Whenever either one of the design editors (11, 12) is opened and becomes an active editor in view, it will always be updated with the most recent and synchronized user actions. This is due to the undo stacks that store the user actions.

In accordance with an embodiment of the present invention, the undo stacks (15, 16) store actions in last-in-first-out form to enable undo-able and redo-able user actions. Both physical and logical design editors (11, 12) visually representing the same design components differently. Accordingly, both design editors (11, 12) will manage its own undo stack (15, 16). The undo stacks (15, 16) will be updated upon receiving the action from the user or broadcasted action. The unified design model (14) will keep track of the undo stacks (15, 16) to ensure that the physical and logical design editors (11, 12) remain in sync. Both design editors (11, 12) will query the unified design model (14) to obtain their undo stacks (15, 16). This will keep the undo stacks (15, 16) in sync regardless of when the design editor is opened or closed.

In accordance with an embodiment of the present invention, the system (1) is incorporated in an EDA tool for designing electronic systems.

The present invention also proposes a computer-implemented method for design synchronization of electronic systems using the system (1) described above.

The method comprises the steps of receiving the action from the user and transferring the user action to the synchronization manager (13) by a design editor, receiving and analysing the user action, updating the user action in the unified design model (14), and broadcasting the user action to other design editor by the synchronization manager (13) to manage the design synchronization among the design editors, and receiving the user action from the broadcast by the other design editor to perform the user action, wherein the user action is received and updated to the undo stack of each design editor, and the unified design model (14) performs tracking to track the undo stack of each design editor to ensure the design synchronization.

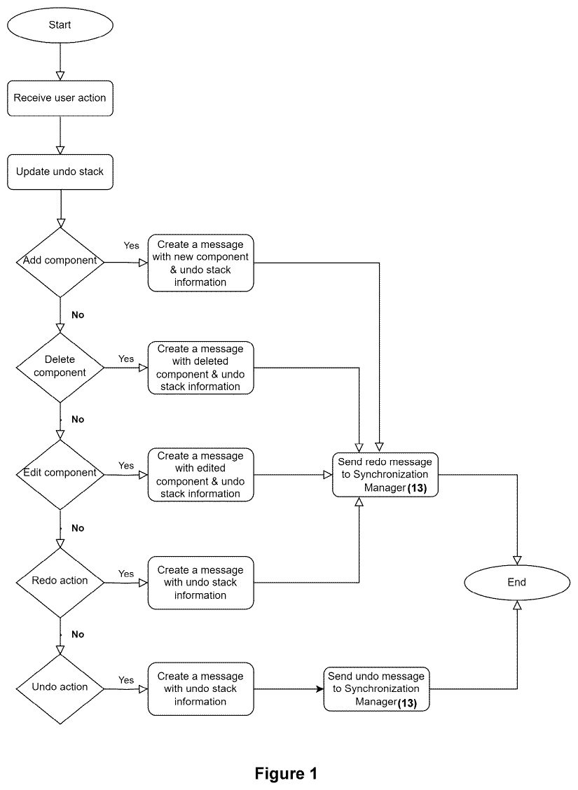

With reference to FIGS. 1 to 3, the invention will now be described in more details.

FIG. 1 is a flow diagram illustrating an embodiment of design synchronization process at the design editor that receives an action from a user. The design editor that receives the user action will update its graphical scene and undo stack, record the undo stack information, and transfer the user action to the synchronization manager (13). The undo stack information is preferably but not limited to count and current index. This information will be used for verification purpose at the later stage.

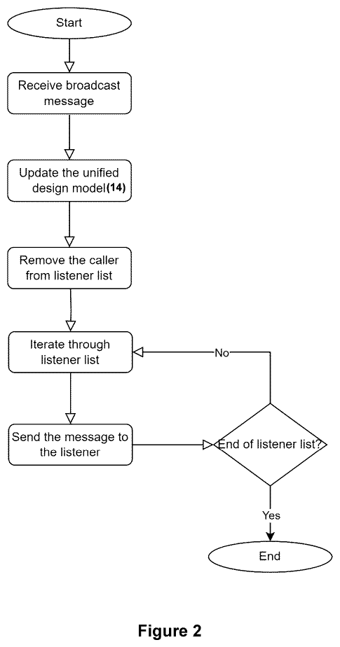

FIG. 2 is a flow diagram illustrating an embodiment of design synchronization process at the synchronization manager (13) that manages the communication among the design editors (11, 12) and the unified design model (14). The synchronization manager (13) receives the user action from one of the design editors (11, 12), analyses the user action that will be broadcasted, updates the unified design model (14), and broadcasts message to the other design editor. Prior to broadcasting the user action, the synchronization manager (13) removes the design editor (also known as a caller) that receives the user action from a recipient list and iterates through the recipient list to broadcast the user action to the selected recipient (also known as a listener), which is the other design editor. The design editor can register and unregister as a listener to control their participation in the broadcast by informing the synchronization manager (13).

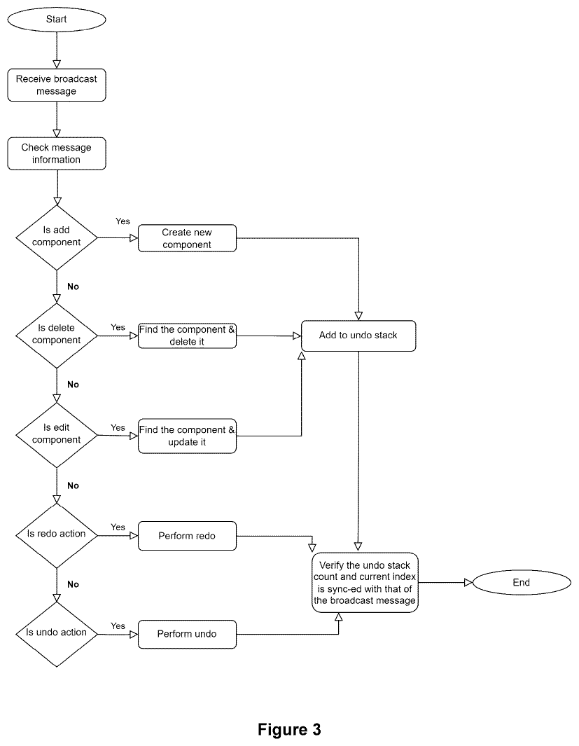

FIG. 3 is a flow diagram illustrating an embodiment of design synchronization process at the other design editor that receives the broadcasted action. The other design editor will analyse the broadcasted action and update its graphical scene and undo stack upon receiving the broadcasted action. After performing the update, the other design editor will verify the information in the undo stack is in-synched with the broadcasted action. The undo stack verification can also be a checksum of the complete undo stack contents. If the user action is not relevant to the specific design editor, the user action will still be added to its undo stack but contains empty graphical information.

The present invention further proposes a computer program product that comprises instructions for implementing the method for design synchronization of electronic systems as described above.

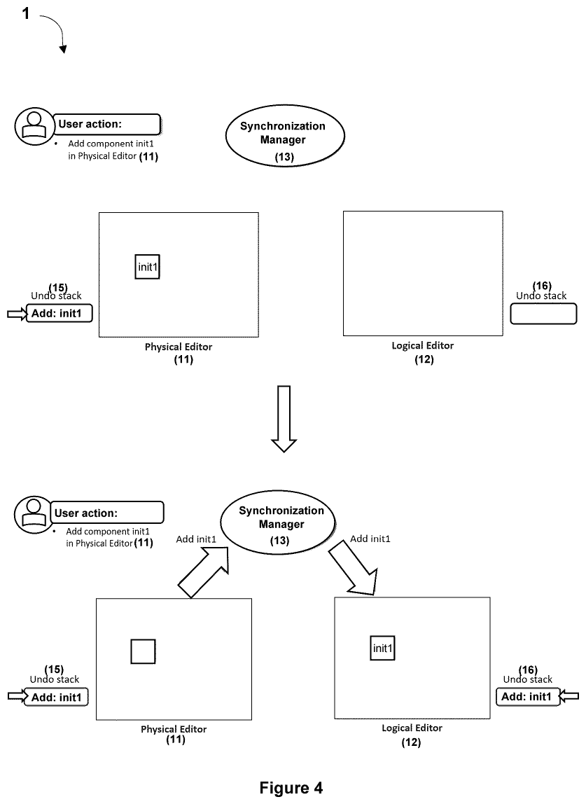

Hereinafter, examples of the present invention will be provided for more detailed explanation by referring to FIGS. 4 to 7. The advantages of the present invention may be more readily understood and put into practical effect from these examples. However, it is to be understood that the following examples are not intended to limit the scope of the present invention in any ways.

### EXAMPLES

### Example 1

FIG. 4 is a flow diagram illustrating the user action that involves adding a component to one of the editors (11, 12), which is the physical design editor (11) in this example. When the user adds a component “init1” in the physical design editor (11), the current index of the undo-stack (15) of the physical design editor (11) corresponds to the “Add: init1” action. Meanwhile, the undo stack (16) of the other design editor, which is the logical design editor (12) is currently empty. The physical design editor (11) will then transfer the user action to the synchronization manager (13) which broadcasts the user action to the logical design editor (12). Upon receiving the broadcasted action, the logical design editor (12) analyses the user action and performs the action which is to create the “init1” component in the logical design editor (12). The undo stacks (15, 16) of both design editors (11, 12) now points to the “Add: init1”.

### Example 2

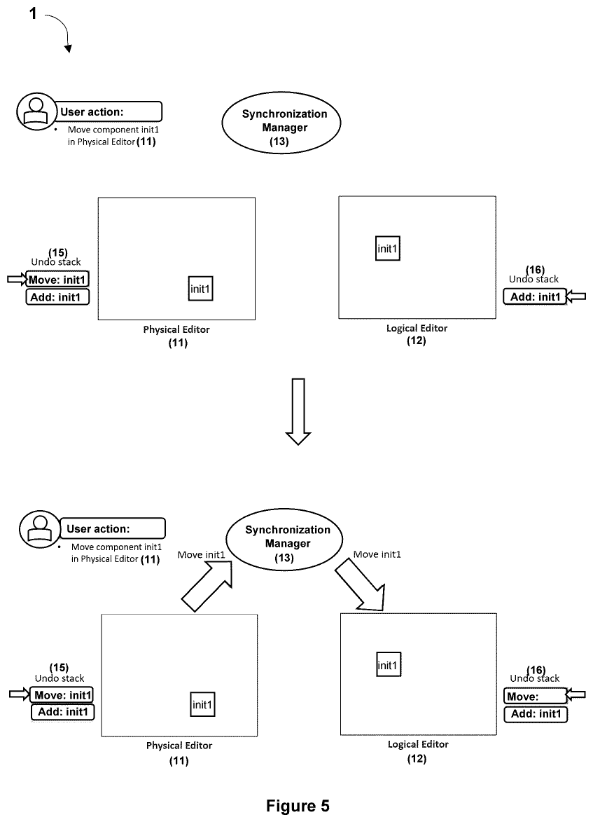

FIG. 5 is a flow diagram illustrating the user action that involves moving the component in the physical design editor (11). When the user moves “init1” component graphical coordinates in the physical design editor (11), the current index of the undo-stack (15) of the physical design editor (11) corresponds to the “Move: init1” user action. The physical design editor (11) will then transfer the user action to the synchronization manager (13) which broadcasts the user action to the logical design editor (12). Upon receiving the broadcasted action, the logical design editor (12) analyses the user action and determine that no action is required, as the physical floorplan and logical floorplan are different. The logical design editor (12) then creates an ‘empty’ user action. The undo-stack of both editors (11, 12) now points to the “Move” user action.

### Example 3

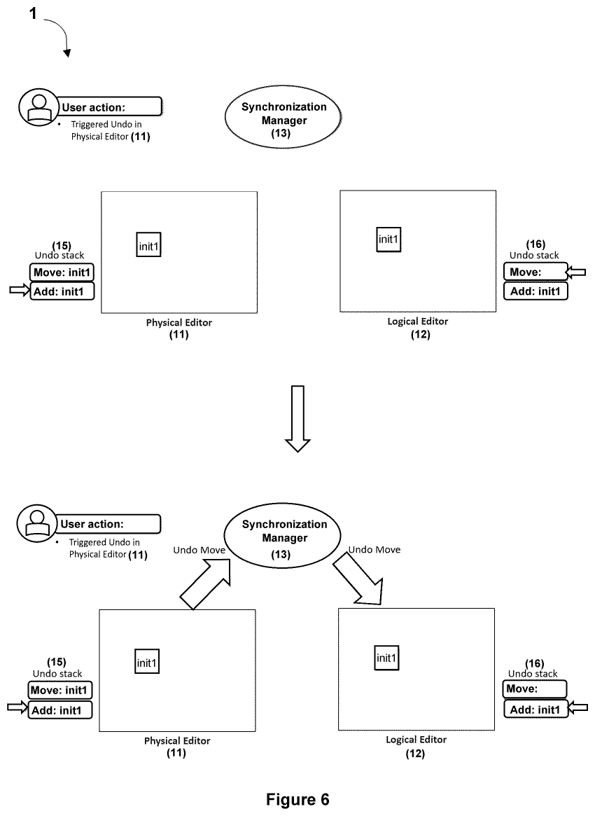

FIG. 6 is a flow diagram illustrating performing an undo user action in the physical design editor (11). When the user triggers undo in the physical design editor (11), the current index of the undo-stack (15) of the physical design editor (11) corresponds to the “Add: init1” user action. The physical design editor (11) transfers the user action to the synchronization manager (13) which broadcasts the user action to the logical design editor (12). Upon receiving the broadcasted action, the logical design editor (12) analyses the user action and determine that undo of the undo stack (15) current index is required. The logical design editor (12) will then perform the undo action. The undo stacks (15, 16) of both design editors (11, 12) have the current index pointing to the “Add: init1” user action.

### Example 4

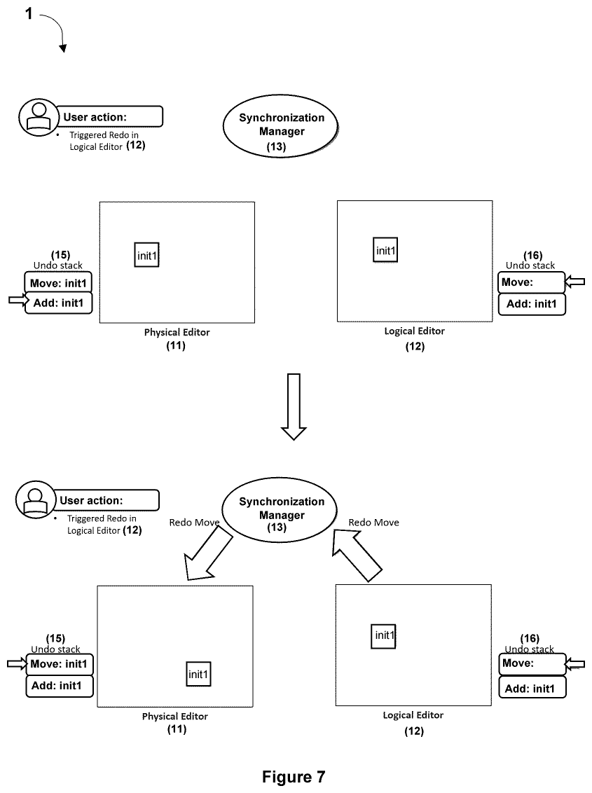

FIG. 7 is a flow diagram illustrating performing a redo action in the logical design editor (12). When the user triggers redo in the logical design editor (12), the current index of the undo stack (16) of the logical design editor corresponds to the “Move” user action. The logical design editor (12) will then transfer the user action to the synchronization manager (13) which broadcasts the user action to the physical design editor (11). Upon receiving the broadcasted action, the physical design editor (11) analyses the action and determines that redo of the undo stack (16) current index is required. The physical design editor (11) will then perform the redo action. The undo stacks of both editors (11, 12) have the current index pointing to the “Move” user action.

In summary, the present invention enables the design created in both design editors (11, 12) to be always synchronized. For example, if the user performs an automatic design creation of 2×2 full mesh topology network-on-chip design components in the logical design editor (12), the same components will also appear in the physical design editor (11) automatically, or vice versa. Both design editors (11, 12) will always share the same repository of design model (14). However, both design editors (11, 12) manage their own graphical models as the same design components. Hence, the design components might be placed differently or organized according to the graphical coordinate algorithm specific to the respective design editor.

The present invention addresses the limitations of the existing electronic system design tools by removing the constraints that limit design creation, debugging and analysis to either physical or logical design exclusively. Through the implementation of the design synchronization system (1) and method of the present invention, electronic system designers now have the flexibility to dynamically switch the physical design editor (11) to the logical design editor (12), or vice versa, enhancing their ability to create and edit designs.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claim.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A computer-implemented design synchronizing system (1) for designing floorplan of electronic systems, the system (1) characterized by:
at least two design editors comprise of a physical design editor (11) and a logical design editor (12), the design editors (11, 12) are connected to a design database associated with a unified design model (14); and
a synchronization manager (13) manages design synchronization among the design editors (11, 12) by receiving an action from one of the design editors (11, 12), updating the action in the unified design model (14), and broadcasting the action to other design editor;
wherein each of the design editors (11, 12) comprises an undo stack (15, 16) to receive an action from a user or broadcast, and to keep track a sequence of actions of the respective design editor, whereby the design editors (11, 12) perform an action according to the action received from the user or broadcast corresponding to the unified design model (14) for design synchronization.

2. The computer-implemented design synchronizing system (1) as claimed in claim 1, wherein the system (1) further comprises a centralized manager for selecting the design editors (11, 12) as recipient of broadcasted actions.

3. The computer-implemented design synchronizing system (1) as claimed in claim 1, wherein the user actions comprise design creation, edition, deletion, undo, and redo.

4. The computer-implemented design synchronizing system (1) as claimed in claim 1, wherein the undo stacks (15, 16) store actions in last-in-first-out form.

5. The computer-implemented design synchronizing system (1) as claimed in claim 1, wherein the system (1) is incorporated in an electronic design automation tool.

6. A computer-implemented method for design synchronization of electronic systems using a system (1) as claimed in claim 1, the method comprising the steps of:
receiving an action from a user and transferring the user action to a synchronization manager (13) by a design editor;
receiving and analysing the user action, updating the user action in a unified design model (14), and broadcasting the user action to other design editor by the synchronization manager (13) to manage the design synchronization among the design editors; and
receiving the user action from the broadcast by the other design editor to perform the user action;
wherein the user action is received and updated to undo stack of each design editor, and the unified design model (14) performs tracking to track the undo stack of each design editor to ensure the design synchronization.

7. The computer-implemented method as claimed in 6, wherein the design editor updates the undo stack upon receiving the action from the user.

8. The computer-implemented method as claimed in claim 6, wherein the other design editor analyses the message and updates the undo stack upon receiving the broadcasted action from the synchronization manager (13).

9. The computer-implemented method as claimed in claim 6, wherein the other design editor verifies the user action in the undo stack is in-synched with the broadcasted action received upon updating the undo stack.

10. A computer program product comprising instructions for implementing a method for design synchronization of electronic systems as claimed in claim 6.
